(19) United States
(12) Patent Application Publication
(10) Pub. No.: US 2026/0070498 A1
(43) Pub. Date: Mar. 12, 2026

(54) COMPONENT FOR VEHICLE AND VEHICLE

(71) Applicant: Isuzu Motors Limited, Yokohama-shi, Kanagawa (JP)

(72) Inventors: Hitoshi KOMATA, Fujisawa-shi (JP); Changwook AN, Fujisawa-shi (JP)

(73) Assignee: Isuzu Motors Limited, Yokohama-shi, Kanagawa (JP)

(21) Appl. No.: 19/281,862

(22) Filed: Jul. 28, 2025

(30) Foreign Application Priority Data
Sep. 9, 2024 (JP) 2024-154945

(51) Int. Cl. B60R 13/02

(52) U.S. Cl. CPC B60R 13/0206; B60R 2013/0293

(57) ABSTRACT

A component for a vehicle includes: a component body as a part of the vehicle, the component body having a plurality of holes in one surface; and a target mark provided around a position of a predetermined hole in which an external thread is disposed among the plurality of holes of the component body, the target mark having a convex shape protruding with respect to a surface around the position of a predetermined hole, and being for clearly indicating that the external thread is to be disposed.

### CROSS REFERENCE TO RELATED APPLICATIONS

This application is based upon and claims the benefit of priority from prior Japanese Patent Application No. 2024-154945, filed Sep. 9, 2024, the entire contents of which are incorporated herein by reference.

### FIELD

The present invention relates generally to a component for a vehicle and a vehicle having the component.

### BACKGROUND

A plurality of holes is provided as holes for attaching peripheral components to a component body that is a part of an instrument panel base or the like, for example, during manufacturing of a vehicle. These holes may be formed as screw holes for screws, bolts, or the like, or may be formed as fitting holes, engagement holes, or the like to which other components are attached.

For example, Jpn. Pat. Appln. KOKAI Publication No. 2000-117563 discloses a component having a marker. For example, Jpn. Pat. Appln. KOKAI Publication No. 2009-211740 discloses a mounting structure of an information device such as a Hard Disk Drive.

In a case where an operator moves a line of sight during manufacturing of a vehicle, it is expected that workability is improved if the operator can easily recognize a predetermined hole for disposing an external thread to be attached at a glance from a plurality of holes instead of searching for the predetermined hole for disposing the external thread to be attached from the plurality of holes.

### SUMMARY

According to an aspect of the invention, a component for a vehicle, includes: a component body as a part of the vehicle, the component body having a plurality of holes in one surface; and a target mark provided around a position of a predetermined hole in which an external thread is disposed among the plurality of holes of the component body, the target mark having a convex shape protruding with respect to a surface around the position of a predetermined hole, and being for clearly indicating that the external thread is to be disposed.

### BRIEF DESCRIPTION OF DRAWINGS

FIG. 1 is a schematic view illustrating a part of a front portion of a vehicle according to an embodiment.

FIG. 2 is a schematic view illustrating an example of a surface of a component at a position denoted by reference sign II in FIG. 1.

FIG. 3 is a schematic perspective view illustrating a target mark including a predetermined hole in FIG. 2.

FIG. 4 is a schematic view illustrating a state in which an external thread is disposed in a predetermined hole portion in FIG. 2.

FIG. 5 is a cross-sectional view taken along line V-V in FIG. 4.

FIG. 6 is a schematic view illustrating a comparative example of the surface of the component at the position denoted by reference sign II in FIG. 1 with respect to FIG. 2.

FIG. 7 is a schematic view illustrating a state in which an external thread is disposed in a predetermined hole portion in FIG. 6.

### DETAILED DESCRIPTION

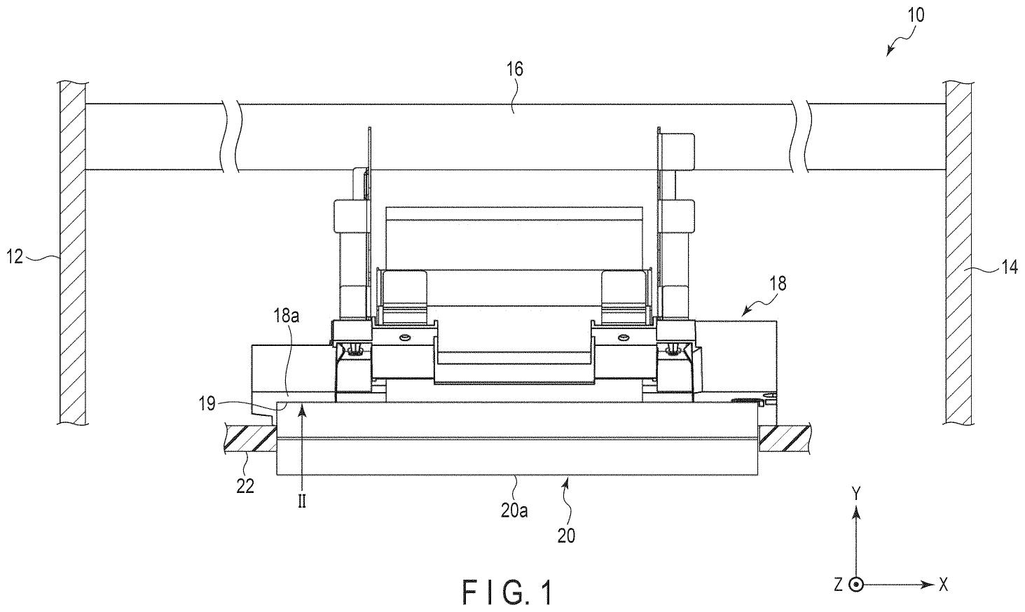

A base material 18 as a component for a vehicle 10 according to the present embodiment will be described with reference to FIGS. 1 to 7. Note that manufacturing of the vehicle 10 here is not limited to a case where the vehicle 10 is set in a travelable state, and includes attachment of various components including a display unit (display assembly) 20 having a display 20a that displays map information, and attachment of auxiliary apparatuses that assist a driver of the vehicle 10 in driving and ensure comfort of an occupant such as an air conditioner.

FIG. 1 is a schematic view of a front side of the vehicle 10 as viewed from an upper side (roof side) of the vehicle 10. An XYZ orthogonal coordinate system is given in FIG. 1. An upper side in a plane of drawing of FIG. 1 is a front side along a +Y-axis direction of the vehicle 10, a right side is a right side along a +X-axis direction of the vehicle 10, a left side is a left side along −X-axis direction of the vehicle 10, and a lower side is a rear side along a −Y-axis direction of the vehicle 10. Note that, in the vehicle 10 in FIG. 1, portions used for description in the embodiment are illustrated, and illustration of other portions is omitted.

Note that the vehicle 10 here may be a so-called engine vehicle, or may be any of an electric vehicle (EV), a hybrid electric vehicle (HEV), a plug-in hybrid vehicle (PHV), a fuel cell vehicle (FCV), or the like.

As illustrated in FIG. 1, the vehicle 10 has, for example, a left-side member 12, a right-side member 14, a tubular beam 16 connecting the left-side member 12 and the right-side member 14, and a base material (instrument panel base) 18, on the front side of the vehicle 10. The beam 16 is fixed to the left-side member 12 and the right-side member 14 with bolts or the like (not illustrated). The beam 16 may have a circular tubular shape or an appropriate polygonal tubular shape.

The base material (instrument panel base) 18 for fixing the display unit 20 to the cab side (rear side) with respect to the beam 16 is fixed to the beam 16. The base material 18 is an example of a component for the vehicle 10. Here, the base material 18 is exemplified as the component for the vehicle 10, but plate materials, block materials, and the like at various positions in the vehicle 10 are allowed as the components for the vehicle 10. Then, for example, the display unit 20 having the display 20a that can be visually recognized by an occupant of the vehicle 10 is fixed to the base material 18.

Note that the base material 18 is formed of a resin material as an example, but may be formed of a metal material.

An instrument panel section 22 is disposed on the rear side (cab side) with respect to the beam 16.

In the present embodiment, the display unit 20 is described as being disposed at a center of the instrument panel section 22 in a width direction, but may be disposed to be shifted to the right or to be shifted to the left.

For example, the display unit 20 having the display 20a visually recognized by the occupant of the vehicle 10 is fixed to the base material 18 of the vehicle 10, and various components such as a wire harness are fixed to the base material 18 of the vehicle 10 by screwing, clipping, or the like.

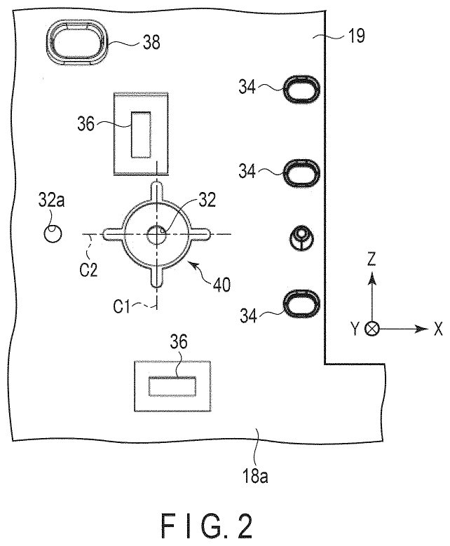

FIG. 2 is a schematic view illustrating a plate-like member (component body) 18a that is a part of the base material 18 as the component for the vehicle 10 as viewed from a direction denoted by reference sign II in FIG. 1. Therefore, FIG. 2 is a schematic view illustrating a surface 19 of the plate-like member as the component body 18a.

As illustrated in FIG. 2, the surface 19 of the plate-like member 18a of the base material 18 has a predetermined hole 32 in which a predetermined external thread 50 is disposed, and one or a plurality of holes 32a, 34, 36, and 38 different from the predetermined hole. Shapes of the predetermined hole 32 and the holes 32a, 34, 36, and 38 are appropriately set.

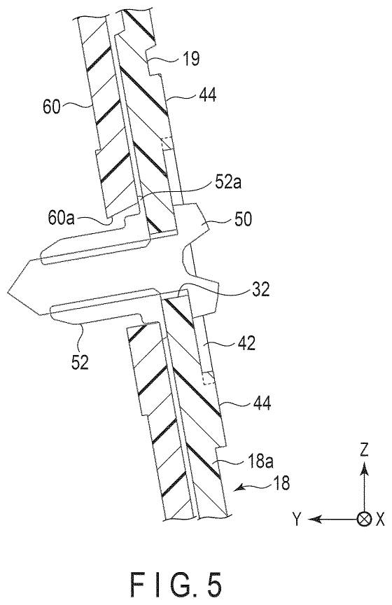

In the present embodiment, an example in which a bolt fastened using a nut 52 (see FIG. 5) is used as the predetermined external thread 50 disposed in the predetermined hole 32 will be described. If an inner edge of the predetermined hole 32 is formed as an internal thread, the external thread 50 that does not use the nut 52 may be used. In this case, the nut 52 may be unnecessary.

The predetermined hole 32 is allowed to have various shapes and various sizes as long as a screw portion of the external thread (bolt) 50 can be screwed or inserted and a head portion does not come out to a depth side of the predetermined hole 32.

A hole 32a different from the predetermined hole 32 is exemplified by a circular hole that is the same in size and in shape as the predetermined hole 32. The hole 34 is exemplified by an elongated hole. The hole 36 is exemplified by a rectangular hole. The hole 38 is similar in shape to but is different in size from the hole 34, for example.

A target mark 40 for clearly indicating that the external thread 50 is to be disposed is formed around the position of the predetermined hole 32 where the external thread 50 is to be disposed among the predetermined hole 32 and the plurality of holes 32a, 34, 36, and 38 of one surface 19 of the base material 18.

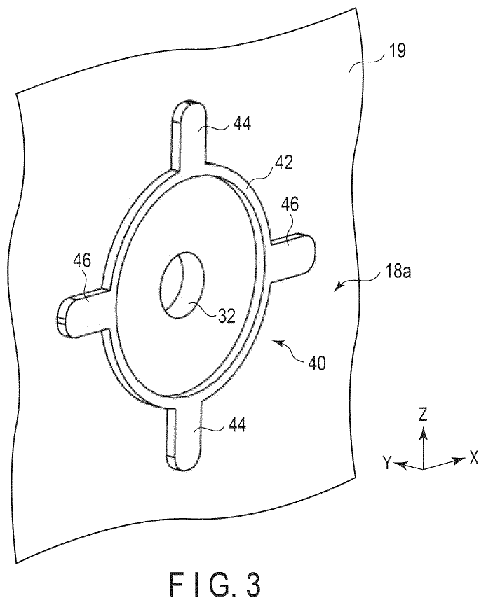

FIG. 3 is a schematic perspective view illustrating the target mark including the predetermined hole in FIG. 2. As illustrated in FIG. 3, the target mark 40 has a convex shape protruding with respect to the surface 19 around the position of the predetermined hole 32 where the external thread 50 is to be disposed.

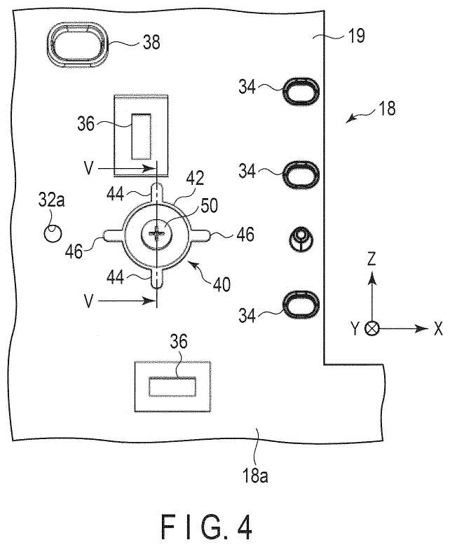

FIG. 4 is a schematic view illustrating a state in which the external thread 50 is disposed in the predetermined hole 32 in the target mark 40 in FIG. 2. FIG. 5 is a cross-sectional view taken along line V-V in FIG. 4.

As illustrated in FIGS. 2 to 5, the target mark 40 includes a circular edge portion 42 concentrically provided with a center of the predetermined hole 32, and a plurality of (for example, two pairs of) ribs 44 and 46 radially extending outward in a radial direction from the circular edge portion 42. It is preferable that four ribs 44 and 46 are disposed at equal intervals in a circumferential direction.

It is assumed that a bearing surface of the external thread 50 is the same surface as the surface 19. The circular edge portion 42 and the two pairs of ribs 44 and 46 preferably protrude by, for example, about 1 mm with respect to the surface 19, that is, the bearing surface of the external thread 50. The circular edge portion 42 and the two pairs of ribs 44 and 46 are preferably formed to be flush with each other, but for example, the ribs 44 and 46 may be inclined so as to approach the surface 19 toward distal ends with respect to the circular edge portion 42. An extension length of the two pairs of ribs 44 and 46 with respect to the circular edge portion 42 is preferably, for example, about several mm.

The circular edge portion 42 has an inner diameter that is at least larger than an outer diameter of the head portion of the external thread 50. Therefore, the head portion of the external thread 50 fits inside the circular edge portion 42. The inner diameter of the circular edge portion 42 is preferably a diameter within several times of the head portion of the external thread 50.

Note that an inner edge and an outer edge of the circular edge portion 42 may be formed as polygons. The circular edge portion 42 and the two pairs of ribs 44 and 46 are formed such that stress concentration is prevented, for example, an edge portion is chamfered.

In the target mark 40 according to the present embodiment, it is not necessary to color-code the predetermined hole 32 in which the predetermined external thread 50 is disposed by separate coloring or the like.

For example, in a case where the base material 18 is manufactured with a mold, the predetermined hole 32 in which the external thread 50 is disposed and the target mark 40 can be formed together with the surrounding holes 32a, 34, 36, and 38. For this reason, the predetermined hole 32 and the target mark 40 are formed by being cut out with the mold, for example, and work such as coloring is not necessary.

Note that a plate thickness of the component body 18a for the vehicle 10 is preferably the same as that in an existing component, for example, in a portion not having the target mark 40.

Then, actually, during manufacturing of the vehicle 10, operator's eyes are guided to an intersection position of a virtual axis C1 along the extending direction of the pair of ribs 44 and a virtual axis C2 along the extending direction of the other pair of ribs 46 among the four ribs 44 and 46 disposed at equal intervals in the circumferential direction of the target marks 40. At this time, the operator can easily grasp that the intersection position of the two virtual axes C1 and C2 is the position of the predetermined hole 32 where the external thread 50 is to be disposed. Therefore, during manufacturing of the vehicle 10, in a case where the operator looks at the surface 19 having the predetermined hole 32 and the plurality of holes 32a, 34, 36, and 38 and the target mark 40 for disposing the external thread 50, the operator can easily find the target mark 40.

In the example illustrated in FIG. 5, the nut 52 is a nut having a flange 52a. Then, a through hole 60a of a plate member 60 is fitted to the nut 52.

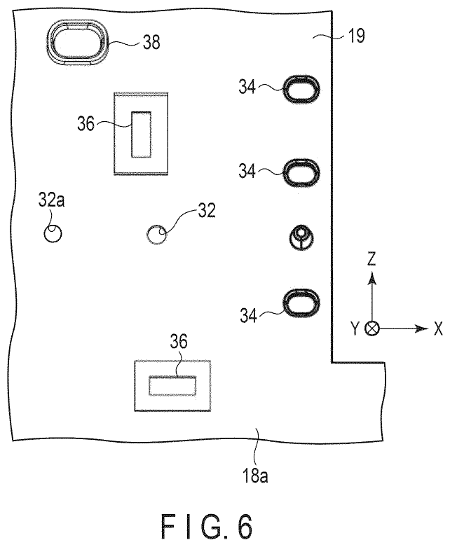

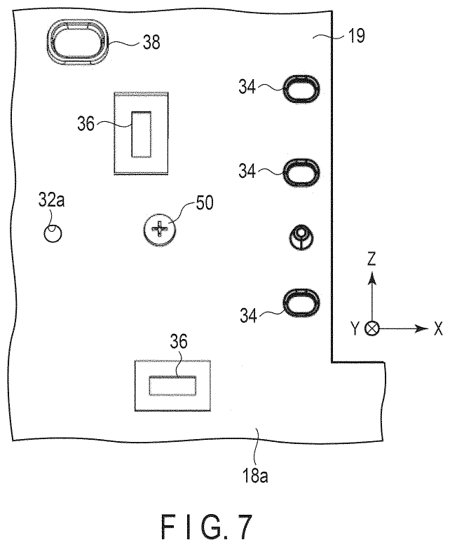

FIG. 6 is a schematic view illustrating a plate-like member (component body) 18a that is a part of the base material 18 as a component for a vehicle according to a comparative example without the target mark 40 illustrated in FIG. 2. That is, FIG. 6 is a schematic view illustrating the surface 19 of the plate-like member as the component body 18a without the target mark 40. FIG. 7 is a schematic view illustrating a plate-like member (component body) 18a that is a part of the base material 18 as a component for a vehicle according to a comparative example without the target mark 40 illustrated in FIG. 4. In FIG. 7, the external thread 50 is disposed in the hole 32 illustrated in FIG. 6.

In the comparative example illustrated in FIG. 6, the surface 19 around the predetermined hole 32 in which the external thread 50 is to be disposed is merely a flat surface. Therefore, in a case where the operator disposes the external thread 50, the line of sight of the operator is less likely to be directed to the predetermined hole 32 as compared with the example according to the present embodiment illustrated in FIG. 2. On the other hand, the predetermined hole 32 indicated by the target mark 40 according to the present embodiment can guide the line of sight of the operator, and the operator can let a tool to approach the predetermined hole 32 without hesitation in a case of disposing the external thread 50 in the predetermined hole 32, so that work efficiency is improved, and the operator can easily dispose the external thread 50 in the predetermined hole 32.

Therefore, according to the present embodiment, it is possible to provide a component for the vehicle 10 that allows the operator to easily grasp the predetermined hole 32 for disposing the external thread 50 at a glance during manufacturing of the vehicle 10, and the vehicle 10 having the component for the vehicle 10.

Then, as compared with the case where the operator repeats the disposing the external thread 50 as illustrated in FIG. 7 in the predetermined hole 32 of the comparative example illustrated in FIG. 6, it is possible to suppress fatigue of the operator and perform work in a shorter time in a case where the operator repeats the disposing the external thread 50 as illustrated in FIG. 4 in the predetermined hole 32 according to the present embodiment illustrated in FIG. 2. Further, since the predetermined hole 32 can be clearly distinguished as the position for disposing the external thread 50 from the peripheral holes 32a, 34, 36, and 38, and the like, it is possible to prevent erroneous disposition of the external thread 50. Therefore, in the manufacturing process of the vehicle 10, it is possible to smoothly proceed to subsequent work.

In the present embodiment, a part of the front portion has been described as an example of the vehicle 10 in FIG. 1, but the target mark 40 for the external thread 50 may be provided at a portion on the rear side, and the target mark 40 for the external thread 50 may be provided at any position of the vehicle 10.

In the example illustrated in FIG. 5, an example of forming the through hole as the predetermined hole 32 has been described, but the predetermined hole 32 is not limited to the through-hole and may be a recessed hole.

Although the surface 19 is illustrated as a flat surface, the surface is not limited to a flat surface, and may be an appropriate curved surface or a surface having appropriate unevenness.

In the present embodiment, as described above, the base material 18 has been described as a component for the vehicle 10. In a case where the vehicle 10 is distributed, if there is a component that can be recognized as the target mark 40 having the predetermined hole 32 for the external thread 50 inside the circular edge portion 42, the component is recognized as being equivalent to the component 18 for the vehicle 10.

Further, the plate-like member of a part of the base material 18 has been described as an example of the component body 18a, but the entire part of a certain component except for the target mark 40 may be recognized as the component body 18a.

Further, in the present embodiment, an example of using the circular edge portion 42 and the two pairs of ribs 44 and 46 as the target mark 40 has been described. However, if the line of sight of the operator can be gathered in the predetermined hole 32 without separately coloring the component 18 itself, it can also be used as the target mark 40. Therefore, the configuration of the target mark 40 can be variously changed. Also in this case, the target mark 40 preferably protrudes from the surface 19. In this case, for example, the plate thickness of the component 18 is not reduced, and the strength of the component 18 is easily maintained.

In addition, although the example in which the number of ribs 44 and 46 is four has been described, the number of ribs may be three, or five or more, disposed at equal intervals on the outer periphery of the circular edge portion 42 around the predetermined hole 32 as a center.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A component for a vehicle, comprising:
a component body as a part of the vehicle, the component body having a plurality of holes in one surface; and
a target mark provided around a position of a predetermined hole in which an external thread is disposed among the plurality of holes of the component body, the target mark having a convex shape protruding with respect to a surface around the position of a predetermined hole, and being for clearly indicating that the external thread is to be disposed.

2. The component according to claim 1, wherein
the target mark includes:
a circular edge portion having a diameter larger than an outer diameter of a head portion of the external thread and concentrically provided with a center of the predetermined hole; and
a plurality of ribs radially extending outward in a radial direction from the circular edge portion.

3. The component according to claim 2, wherein
four of the plurality of ribs are disposed at equal intervals in a circumferential direction.

4. The component according to claim 1, wherein the component body includes an instrument panel base.

5. A vehicle comprising: the component according to claim 1.
